(19) United States
(12) Patent Application Publication
(10) Pub. No.: US 2009/0000038 A1
(43) Pub. Date: Jan. 1, 2009

(54) Plier tool combination

(76) Inventor: Stephen J. Padden, Ventura, CA (US)

Correspondence Address: Colin P. Abrahams, Suite 400, 5850 Canoga Avenue, Woodland Hills, CA, 91367, US

(21) Appl. No.: 12/156,207

(22) Filed: May 30, 2008

Related U.S. Application Data
(60) Provisional application No. 60/932,500, filed on May 31, 2007.
(60) Provisional application No. 60/964,616, filed on Aug. 14, 2007.

(51) Int. Cl. B25B 7/22

(52) U.S. Cl. 7/128

(57) ABSTRACT

A foldable plier combination tool comprises a foldable plier having a working head portion and a handle portion having a pair of arms which are operable to manipulate the working head portion to open and close. At least one of the arms is pivotably connected to the foldable plier so as to move between an extended position where the plier is unfolded and a retracted position where the plier is folded. The arm receives at least a part of the working head portion when in the retracted position. The combination also includes an associated tool for connection to the foldable plier.

### CROSS REFERENCE TO RELATED APPLICATIONS

This application claims the benefit of U.S. Provisional Patent Application No. 60/932,500 filed May 31, 2007 and U.S. Provisional Patent Application No. 60/964,616 filed Aug. 14, 2007, both of which are incorporated herein by reference in their entirety.

### FIELD AND BACKGROUND OF THE INVENTION

This invention relates to a plier tool. In one aspect, the invention is for a plier, foldable or otherwise, which may be permanently or detachably connected to a main body such as that of a tool or knife body.

A plier tool in accordance with the invention may have a number of benefits and advantages. Folding pliers are prized for their compact construction and versatility. Typically, folding pliers may be built to accommodate a variety of tools. They can also hold a wide variety of jaws to grip, crimp or cut. However, their folding construction limits the size and shape of the type of tools or other accessories which can be constructed as a part thereof. It is often desirable to have a full size knife or other tool, yet the small tools and plier functions are also prized. While it is possible to carry the two items separately so each can be used in a particular application, it is not always convenient or practical to do so.

It is also possible to make a cavity inside a tool handle that will hold a miniature plier. However, this often results in a cumbersome tool not particularly easy to use, and can also result in the plier tool being lost.

### SUMMARY OF THE INVENTION

The present invention, in one aspect, facilitates the inclusion of a folding plier into a main tool case without adding any additional or any significant bulk to the original tool. In fact, the plier in accordance with one aspect of the invention may actually complete the body of the main tool case. The user has immediate, convenient access to the plier portion of the tool composite as well as the tool(s) which may be provided in the main body.

The plier of the invention may be connected permanently or detachably. If detachably connected, the plier tool of the invention offers the added advantage of allowing use of the plier and the main tool(s) in the body simultaneously and separately from each other.

By securely incorporating the plier into the main tool/knife body, the user may well have a better grip on the plier and it can consequently be more effectively maneuvered and operated. The main case also offers better leverage than can be achieved with the traditional short arms of a compact plier.

In accordance with one aspect of the invention, the plier tool may have a main tool body with two or more folding plier components permanently or detachably connected thereto. Typically, folding pliers are built to accommodate a variety of tools. They can also hold a wide variety of jaws to grip, crimp or cut.

It is often desirable to have two different sets of jaws, for instance a plier type tool and a scissor or a plier and a wire stripper. While it is possible to carry two folding plier units separately each having the different and desired feature, it is not always convenient or practical to do so.

As such, the present invention in one aspect thereof allows the user immediate and convenient access to the plier jaws on either end of the tool. Furthermore, access is preferably also provided at the same time to all of the additional small tools which may be present in the plier arms.

The plier tool of the invention, preferably of a compact nature, can be connected either permanently or detachably in a manner which allows it to be easily released and separated from the body and conveniently re-assembled. If detachably removable, the plier tool of the invention preferably offers the added advantage of allowing use of both sets of plier jaws (tools) simultaneously.

The plier tool of the invention may have a double ended construction which preferably creates a single main body. This offers the user a better grip on the two fold out tool components (for example, the plier head and wire cutter, etc.) and also better leverage than can be achieved with the traditional short arms of a compact plier.

The plier tool of the invention is not intended to be limited to miniature “keyring” or pocket tool size type pliers. It also allows the inclusion of a full size pliers in a tool composite. This provides for many combinations of tools useful and capable of heavy duty applications. When connected the two or more sets of folding pliers offer a single secure grip that is excellent for heavy jobs.

The plier tool of the invention may comprise articulated arms such as those found in a traditional folding plier used as functional elements of main tool bodies. This aspect has several benefits. Many tools require articulated parts to secure or act as guards or covers for internal parts. These articulated parts are typically of one piece construction with no additional use than their primary function. The current invention may incorporate arms such as those that are found in traditional folding pliers. These arms offer very strong construction for a variety of tools including a corkscrew and a seat-belt cutter forming a rescue tool or part of a rescue tool. These specialized tools need to withstand considerable leverage when in use and the construction of the plier in the present invention may be configured to provide that strength. Further, the arms may provide the added benefit of many small tools that can enclosed or contained, wholly or partially, within them, with no additional bulk.

Products(s) incorporating this aspect of the invention can be designed have many different appearances and configurations. For example, the handle(s) can be ergonomically constructed, with many complex curves and surface textures made from molded or formed metal, and composites or plastics (including transparent materials). They can also be made using simpler construction of folded and formed sheet metal (or metal, composite or plastic slabs) or a combination of all the above methods and constructions.

The folding plier may be built into a variety of different types and purpose tool cases. Thus, the plier can be compact or full size or anything in between. As examples only, and without limiting the scope of the invention, the jaws of the folding plier can comprise (among others): plier; crimper; wire cutter; wire stripper; line cutter; shear; metal shear; scissor; pruner; pet nail clipper; and cigar cutter. The blade shapes can be (among others): serrated or plain; tactical; hunting; utility; sheeps foot; emergency (rounded end); gut hook; pruning; diving; and filet.

As further examples only, the small tools in the folding plier can include (among others): blades (various); saws (various); files (various); screwdrivers; can/bottle opener; disgorging tool (fishing); scraper-divot tool; cigar cutter-piercer; handcuff key; and pen and/or pencil.

Also as examples only, the main body can be (amongst others things): knife-large scissor/cutter/plier; magnesium alloy fire starter and striker; screwdrivers/socket/extension; wrench(es)-saw(s)-file(s); hammer/nail puller/“catspaw”/awl; stapler—(regular or hammer type); tape measure-flashlight-lighter; compass-lens-thermometer-GPS; timepiece (analog or digital); divot tool-golf tools; corkscrew-ice pick-wine tools; cigar cutter/cigar tools; carpenter tools-level-chisels; wire stripper/electrician tools; rescue tool/ems tool (inc. seat belt cutter widow breaker); weed fork-dive knife.

In accordance with another aspect of the invention, the folding plier may be built into a variety of tool cases. The back of tool can have a lanyard attachment or a pocket/belt clip, which may be made of molded plastic or metal, or it may be stamped or formed of sheet metal. It may comprise a folding knife, which may have more than one blade, or saw etc. It may also combine with a flashlight function. It may be locking style or not, and if lockable, lock possibilities may include a spring lock, liner lock and/or frame lock.

The tool case may be a utility knife, which may use standard size blades or custom made parts constructed and designed for specific purposes. There can be more than one blade, and the blade include one that either slides out or folds out. The blade shapes and types can be selected from: serrated or plain; carpet cutter; curved; wood carving blade; paper cutting blade; a pruning blade or any combination of blades.

The folding plier can built into a further variety of tool cases. These include the use of a folding knife. If made with a shorter overall handle length, the folding knife may accommodate a longer folding plier with longer plier or shear jaws. A wine tool may also be provided.

A pet tool may have plier jaws that comprise a pet nail/claw trimmer. This can have a depth safety gauge to avoid pet injury. The main body can hold (among other things:) brushes and combs; container(s) for liquids and powders; a photo holder; files; and dog waste bags.

A fishing tool may include a weigh scale in the handle body. It could have a snap hook hook, loop or carabineer type attachment. It could also include (among others:) ruler or tape measure; stringer holder; fish scaler; fillet blade; and disgorger.

Two folding plier heads may be built into one tool case. One aspect of the invention allows two different plier and/or shear tools in one main body. This area and a similar area on other side of the tool can hold (among other things) all the tools mentioned above plus: level; flashlight; weeding tools; seat belt cutter; line cutter; fold out lens; fold out compass; fire starter; and a watch.

These embodiments allow two different plier or shear tools in one main body. Preferably, this section (on both ends thereof) is just long enough to hold the plier or shear heads. Such a body (and possibly others described and illustrated above)) may require some reinforcement to stiffen and support the main body. For example, an extension can be added to the fold out plier arms to allow for better leverage. This can be done on one side or on both sides and would preferably be designed to be comfortable to use.

A folding plier in a screwdriver or socket tool case may be provided. Sections on each side of the case may open to reveal bits including a screwdriver with operational heads that are flat, Phillips, Torx, Allen etc., awl, nail set etc. Punches for paper, leather and the like may also be provided.

The top section of case may, in one embodiment, open to reveal bits stacked vertically. These include screwdrivers (flat, Phillips, Torx, Allen etc.), awl, nail set etc., and punches for paper, leather and the like. The socket in the main body can also have a ratchet mechanism to allow easier use. An extension socket can be added to either design to offer more reach. The extension socket may be stored in case.

A detachable folding plier may incorporate one or more or a combination of: a magnet to magnet (or magnet to steel plate) attachment; and a single locking post in the center, which may allow the pliers to be attached or detached without opening the arms. Edges would preferably not have sharp points. The devices above can be used to attach plier to plier or plier to any other main tool or knife body.

One method is to insert a plier arm locking stud (A) into back of tool or into matching plier arm. The plier arms are opened, and the plier rotated until it locks. The plier is then closed.

The methods above can be used to attach the plier to the plier or the plier to any other main tool or knife body. There may be several ways to accomplish the same docking result. All should preferably be secure so that there is a secure junction and the final combined tools feel like one piece.

### Plier Completing a Tool Case

The invention allows a folding plier to be carried as part of a thin card like case. This can be an amorphous shape, a variant on a circle or rectangle or a credit card size.

One aspect of the invention is to create a thin substrate that contains a working plier. The arms of the plier will likely be without additional tools but do not have to be. They may slot into an area of the case that can be close to the thickness of the plier head and jaws. When fully inserted into the main body of the card the finished result can be a largely flat substrate. The pliers do not add significantly to the overall card thickness and they allow inclusion of many separate tools that can be used independent of the plier head.

The arms of the plier can be a variety of shapes. The thin substrate holding the plier can be formed into a tool belt, backpack or other bag, belt or container. Even a molded plastic bucket or a pad for kneeling while gardening. It can be stiff or flexible.

One aspect of invention is a compact, multifunction tool in a generally thin and flat shape. One objective is to create items that are typically as thin as practical for the tools they carry, and are convenient and functional. The tools and concepts described here can be used in the removable plier main body and vice versa. Some examples are set forth below:

(1) The main body holds all the necessities for basic survival: fire, signal whistle, knife, light (or compass and lens). It can also hold other items if space allows.

(2) The fire starter may be a magnesium alloy bar which can be used to create sparks. This can be attached by adhesive, frictional, magnetic, or mechanical means or a combination of them. Some examples:
(a) The fire starter can be glued or permanently fixed to the of the main body.
(b) There can be a shallow cavity along one side of the main body that has a recess substantially the same as the shape of the fire-starter. The recess may accept part of the diameter of the fire starter bar, leaving the rest open to use. The ends of the recess may form a more complete enclosure for the fire starter bar, so that it releasably connects into the recess. In this position it can be used to create sparks or it can be removed from the main body. Once removed it can be hand-held or can be re-inserted into a cavity in one edge of the main body. Inserted this way, the main body may act as a handle for the fire starter as sparks are made.
(c) The main body can have a shallow track along at least part of one edge. The track starts at one corner of the main body. At its opposite end there is a hole or socket to accept one end of the fire starter bar. This secures one end of the fire starter bar while the other is secured by a sturdy, removable bracket of metal, plastic, composites or ceramics. This allows the bar to be replaced when worn.
(d) The fire starter can have a formed or molded handle and can insert into a cavity within the card or can snap into a cavity on the surface of the card.
(e) The fire starter may require a striker. This can be the blade, preferably the notched area on the blade back. It can be an area on the case that is provided for the purpose. Or it can be a completely separate tool.

Other cards may have an area such as an oval hole. This may be used to hold various components. Some examples include lens/compass insert and light/switch insert. However, once these components are built into the tool card, the card may have to be destroyed to remove them. It would be very beneficial if they were interchangeable. However, in such a thin substrate this may be difficult. A removable component may be a micro flashlight, a compass/lens component, a watch, a smart card element, a computer memory element or other tools that can fit. The current space may preferably be about 1.25″ by ¾″. This space can be larger or smaller depending on the main case dimensions.

(3) The removable element may be held in place by two screws that attach the component surface layer to the main case body. The positions of the screws and the exact shape of the components can vary within the spirit of the invention.

(4) The parts of the removable elements need not be connected to each other when they are removed from the main case. It is therefore desirable to have a separate case to hold only these elements. With this case the additional component(s) can be carried independently of the main case. Yet they are still interchangeable with the component that is in the main case. The case can be of varied shape and size. The case that may be small enough to act as a zipper pull or keyring accessory.

(5) A signal whistle may be built into the main case. This is a very thin but loud signal whistle. The case can be designed to accept other items in this area in later iterations.

(6) The knife can be several different shapes and they may be made of one piece metal construction.
(a) Knife handle with open or closed loop of steel. This provides a sturdy grip for general use. The hole in the handle removes a lot of weight while adding traction for the fleshy part of the thumb while the handle is in use.
(b) Knife with a two finger recess. This handle is shaped to fit comfortably with the index and second finger while the thumb rests on the top edge of the blade. It creates a very secure grip for general cutting and is ideal for field dressing small game. It is also extremely strong and light.
(c) All the knives may have a notched area on the top edge of the blade. This is provided for grip and also as a “striker” area for the fire starter. The knives can be useful with or without the notches.

There are several ways to attach the pliers to the folding tool, as described below:

(A) The arms of the folding tool are empty. This leaves space so that the pliers can slide into a recess created in the main body. There may be a releasable means to secure the pliers once it is attached to the case. This may be frictional, magnetic, mechanical or combination of these means.

(B) The arms of the folding tool are empty and they are narrow along the outer edges (when closed). They can slide into recessed channels in the main body.

(C) A combination of both the above insertion methods could be applied to achieve the same result.

(D) The folding tool arms can have a complete shape on one side and an abbreviated shape on the other (enough to add sufficient strength and resistance to torque). This could be true of one or both arms of the tool. This allows the pliers to slot into the card and attach by frictional, magnetic and/or mechanical means.

(E) The folding tool can have in one or both of the arms, additional tools such as knives, saws, files, screwdrivers, pens etc. If the folding tool has a size that is similar in length to the overall main body, this will limit the structural integrity of the main body. However this could be remedied with very strong material construction or a longer main body.

A component is described that holds a wide variety of tools and tool combinations. This component can have a cross section that is cylindrical, hexagonal or any other shape that is practical for the purpose. This could be attached in many different ways: Such as having flanges or projections that allow it to be screwed into the case. It could also be permanently molded or secured in the case. However the most versatile use is as an interchangeable component that attaches and detaches from the case when needed.

It should be understood that the tools or features can be mixed with each other to create new combinations for various specific uses.

### Construction

In one embodiment, the plier card is likely to be thicker than typical tool cards. Also it may hold at least some tools in a back-to-back relationship. This may necessitate some structure for separating the layers to keep these tools apart. Since there may be a large cavity or cutout in the main body, it is important that strength is maintained. Therefore, the case may be made of three layers (although this is not mandatory). All three layers can be the same material, in solid or translucent. They can be different materials such as metal, plastic, ceramics or composites, or a combination such as a metal central plate and a plastic molded covers, or vice versa etc. The edges of the case can be flat, angled or curved.

The folding tool may be a wine bottle opener. This can be simply a corkscrew with two arms that fold open to form a “T”, or it can have a corkscrew and a secondary arm that is a lever to assist with removal of a cork. The complete assembly inserts into the main body in a similar fashion to the folding pliers. Overall the corkscrew component when folded can be flat or it can bulge along the area where the corkscrew is located. This will allow a thinner substrate for the main body. The arm(s) of the corkscrew can be shorter than the length of the corkscrew.

Survival card fire starter: To create sparks a metal surface must be scraped along the fire starter. If this is done when the fire starter is inserted or attached to the edge of the card, the metal striker may make contact with the card at the end of the striking stroke. This contact can possibly damage the surface of the card. A mechanism can be added to protect the card surface from damage when this happens. This could be a steel or ceramic guard or a modified profile of the card. There are several different ways to construct such a guard.

Plier Card or Plier/knife and detachable plier: The detachable pliers and/or the main body can be of plastic or rubber or some sort of composite. In this way they could be toy tools for children or dad and son's tools.

A detachable mini plier that is attached to a main body that is a folding plier: The main body can be long to allow inclusion of many different tools in the arms or shortened as shown to make the overall combination as compact as possible. The arms can include individual tools such as a knife, can opener, screwdrivers, saws, files etc. They can include the cylindrical component shown as a card accessory, or a fire starter among other things.

Many different tools can be enclosed in the arms of the main plier body. It is also possible with some of the attachment methods that small tools could be in the arms of the mini plier.

Alternate shapes for arms of mini plier: The arms can be very narrow towards the ends. The mini plier and the main plier can have similar jaws or completely different jaws. The jaws can be of any style such as shear, scissor, needle nose, crimper, etc. The mini plier can be attached using all the various methods that have been outlined with the plier card drawings.

Shortened overall size with detachable plier arms overlaying the main plier head: Mini plier arms can lay over the main body plier head. There may need to be open areas in the arms to allow this.

### BRIEF DESCRIPTION OF THE DRAWINGS

FIGS. 1 to 3 are side views of a folding plier and knife in accordance with one embodiment of the invention;

FIGS. 4 to 6 are side views of a folding pruner and folding saw in accordance with one embodiment of the invention;

FIGS. 7 to 10 are side views of a folding plier and hammer in accordance with one embodiment of the invention;

FIGS. 11 to 15 are side views of a folding plier and utility knife in accordance with one embodiment of the invention, also showing different shaped blades;

FIGS. 16 to 18 are views of a folding plier and flashlight in accordance with one embodiment of the invention;

FIGS. 19 to 21 are side views of a folding plier and ratchet wrench and screwdriver accessories in accordance with one embodiment of the invention;

FIGS. 22 to 24 are side views of a folding plier and screwdriver socket and accessories in accordance with one embodiment of the invention;

FIGS. 25 to 28 are side views of a folding plier and fisherman's accessories including scale and tape measure in accordance with one embodiment of the invention;

FIGS. 29 to 37 are various views of a plier card showing the card loaded with tools, the plier, and other accessories that can be used as part of the card tool;

FIGS. 38 to 41 show the folding plier included in other tool bodies;

FIGS. 42 to 45 show a folding plier in accordance with an embodiment of the invention;

FIGS. 46 to 51 are various illustrations showing a folding plier tool and card combination;

FIGS. 52 to 57 are various illustrations showing a folding plier tool and card combination in accordance with another embodiment of the invention;

FIGS. 58 to 62 show a gardening tool card in accordance with a embodiment of the invention;

FIGS. 63A to 63F show different embodiments of fitting the folding plier of the invention to the main holding body;

FIGS. 64 to 67 show a card of the invention, and its construction variation;

FIGS. 68 to 70 show a plier card with an edge slot for accommodating various items;

FIGS. 71 to 73 show embodiments of the invention with pliers or shear heads in opposite ends;

FIGS. 74A to 74D show different views of a plier and knife combination in accordance with the invention;

FIGS. 75A to 75D show different views of a plier and knife combination of the invention which provides for a lighting element above the blade;

### DETAILED DESCRIPTION OF THE INVENTION

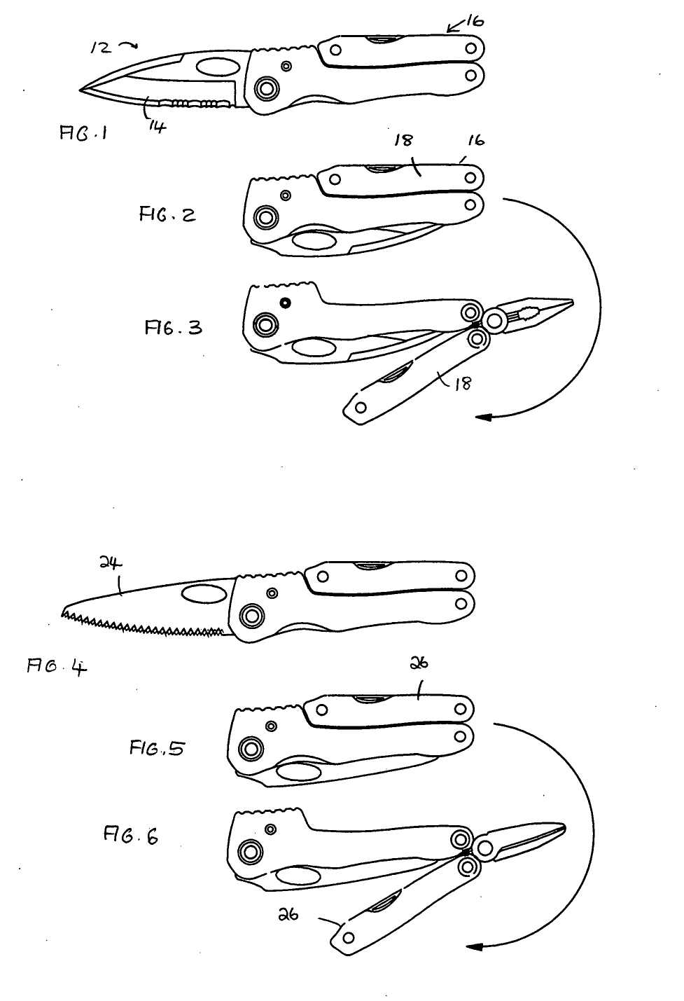

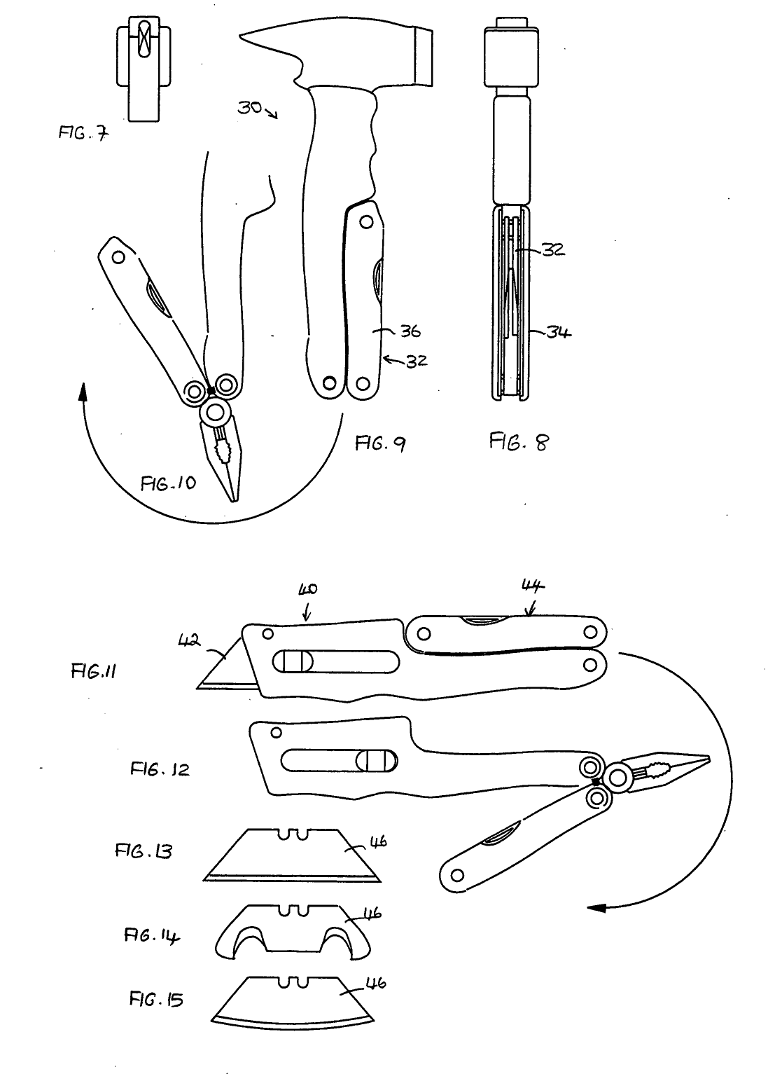

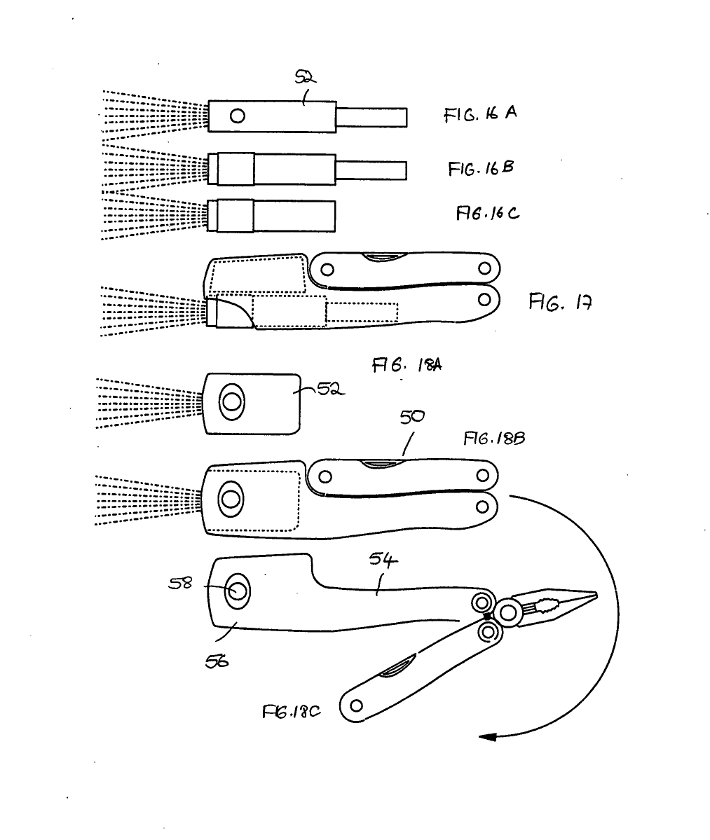

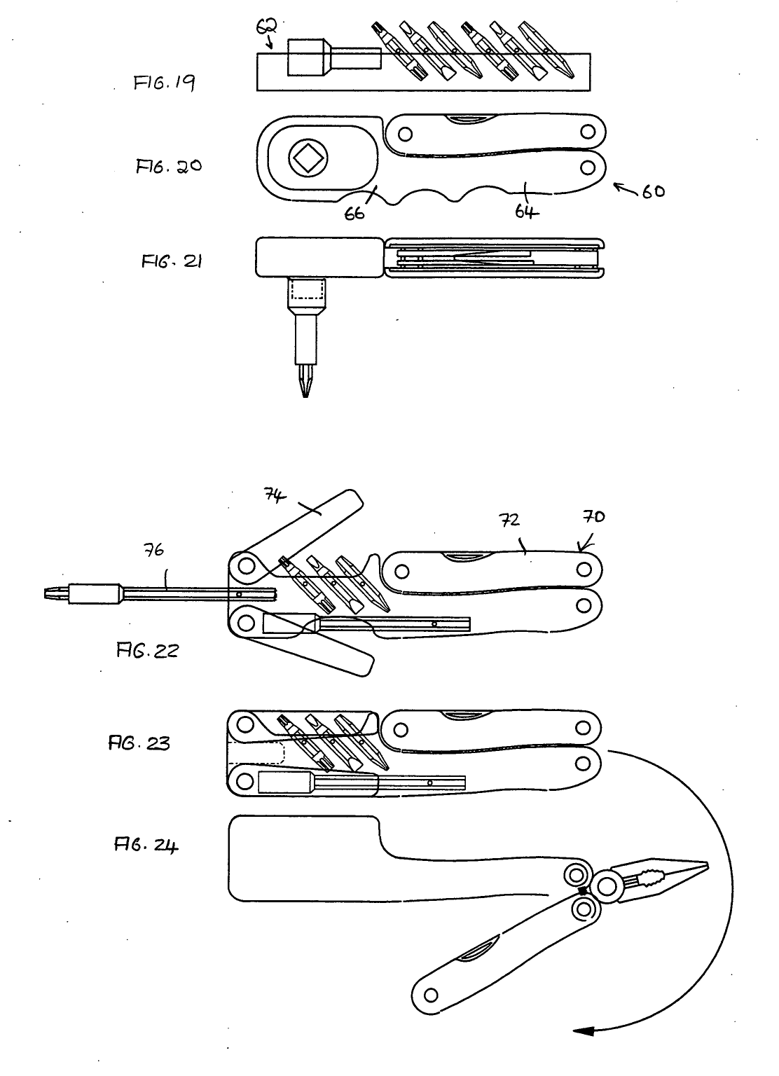

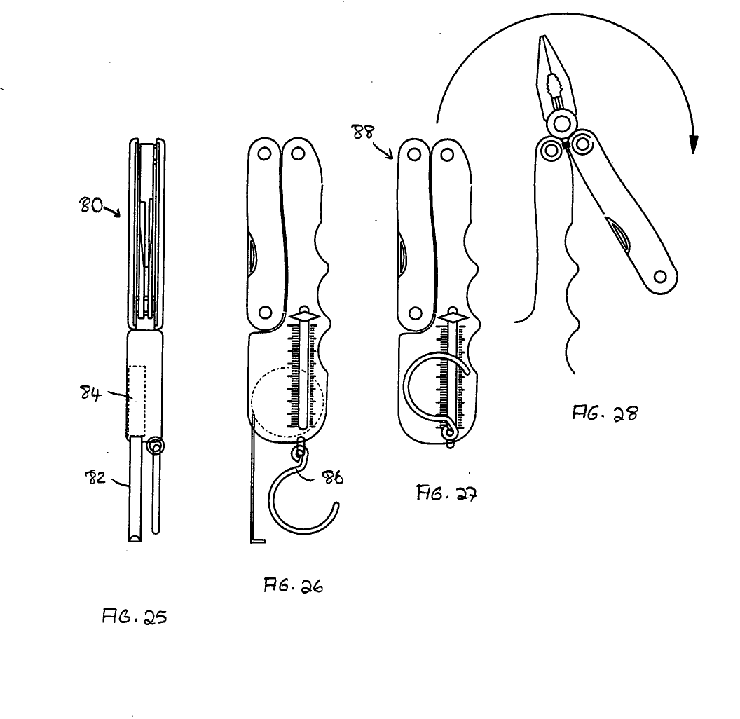

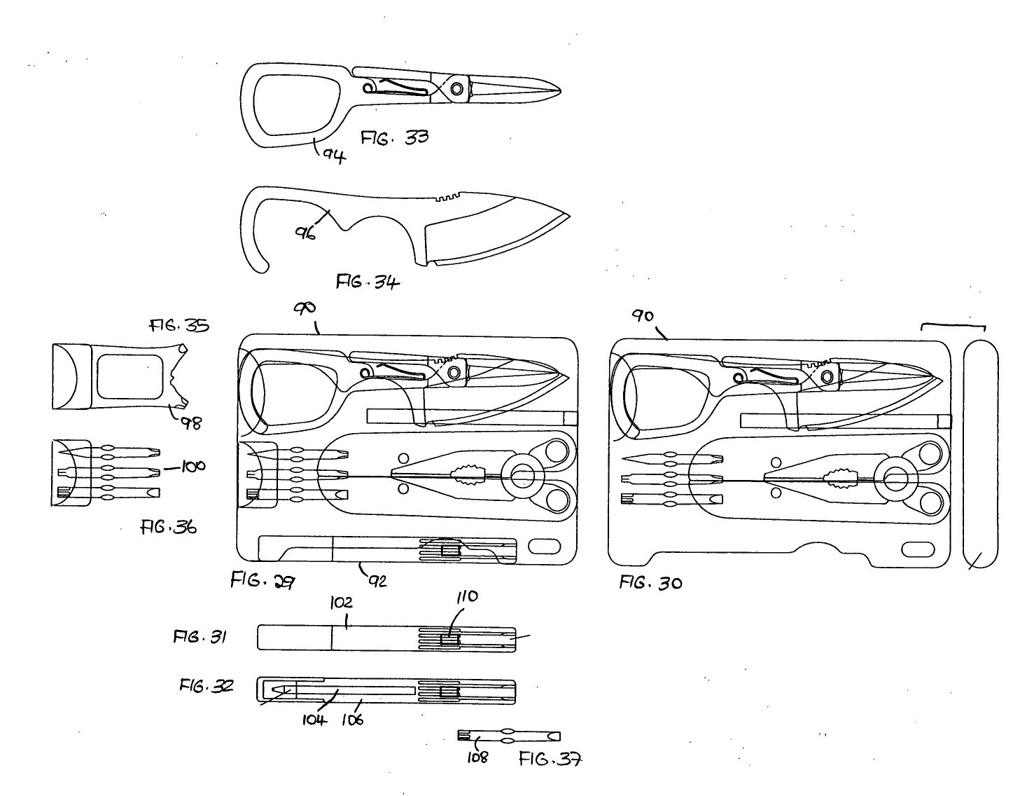

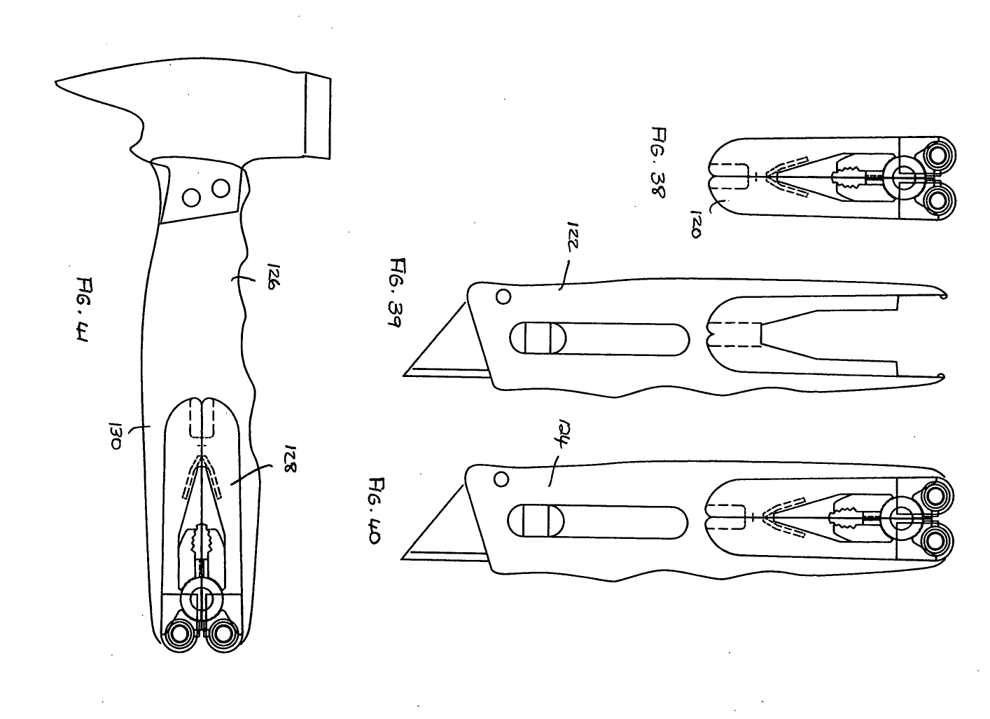

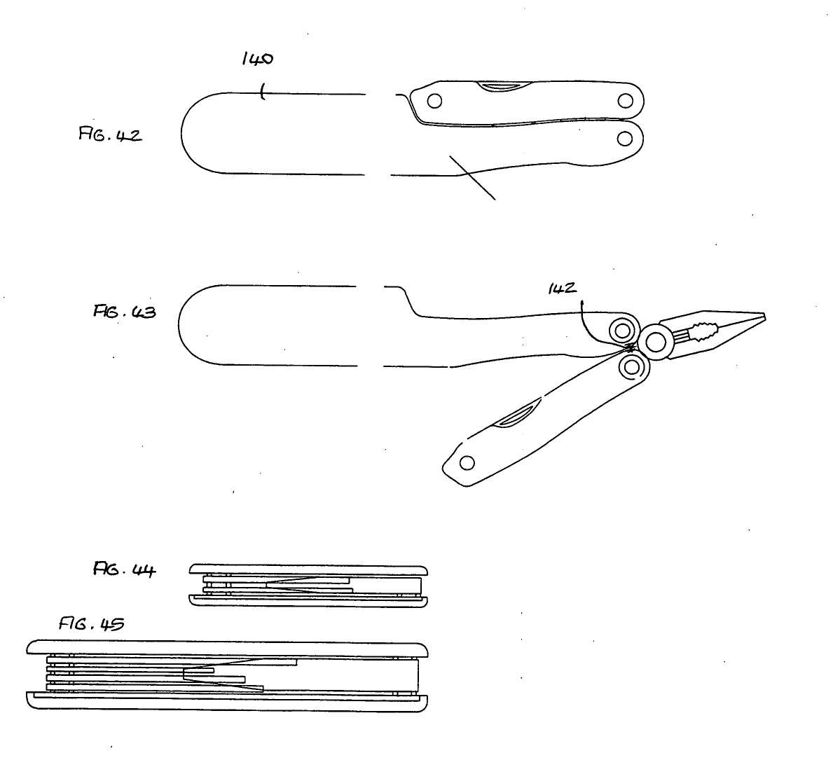

FIGS. 1 to 4 show a folding plier with knife 12 in accordance with the invention. In FIGS. 1 and 2, the knife 14 is extended, while in FIGS. 3 and 4, the knife is retracted. FIGS. 3 and 4 show the movement of one arm 18 of the plier 16, which swings around pivotally so as to move into the open position, as shown in FIG. 4, so that the plier can be used by appropriate manipulation of the arms.

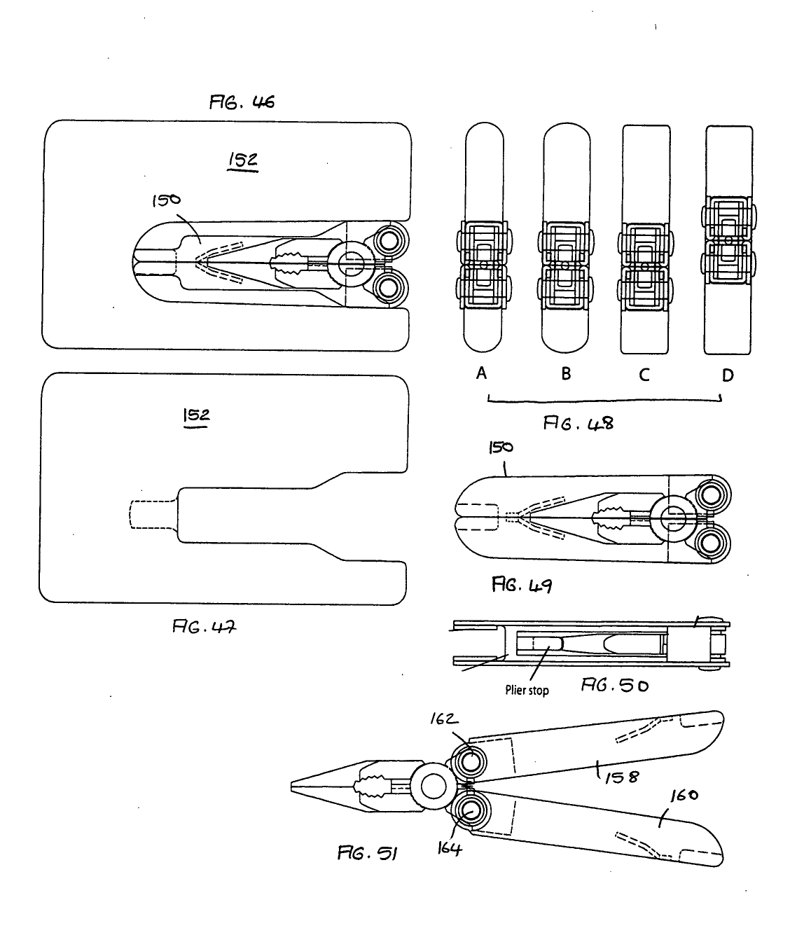

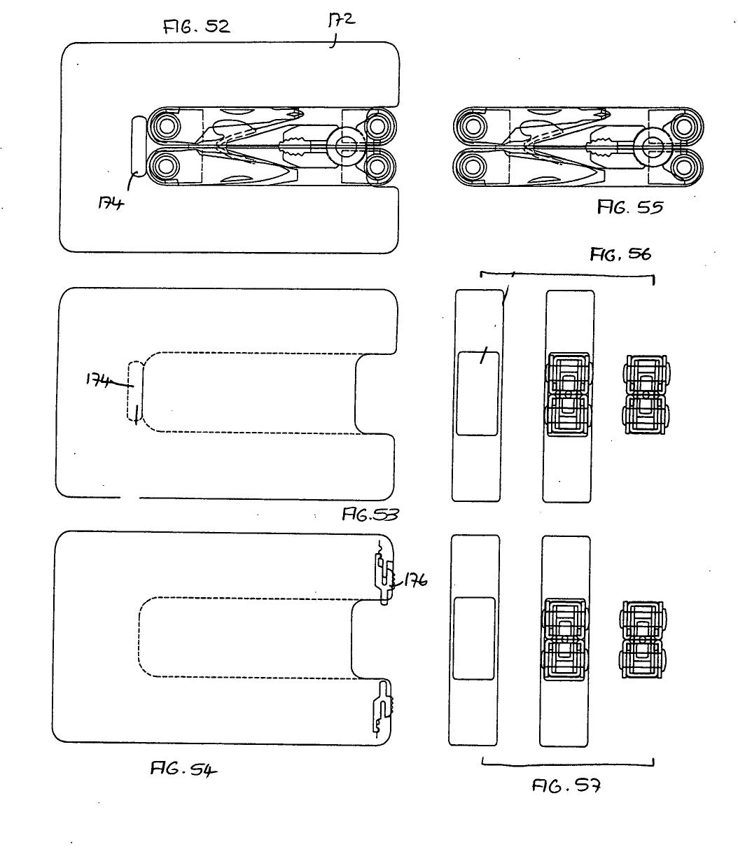

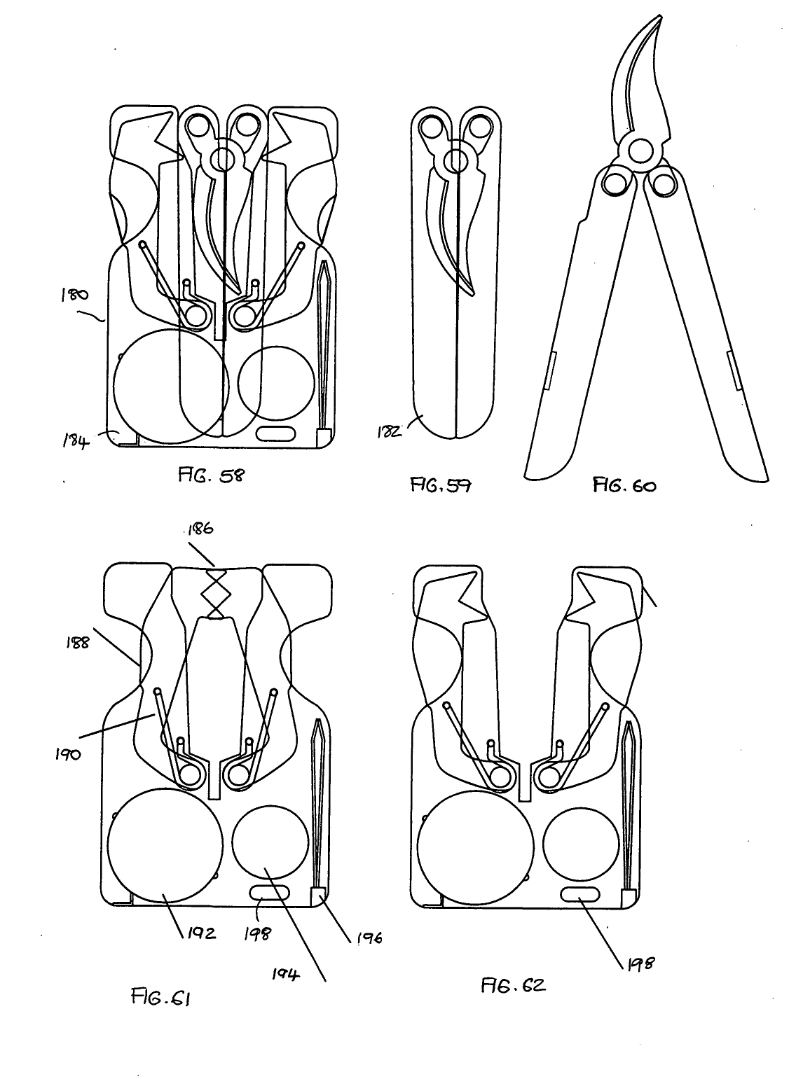

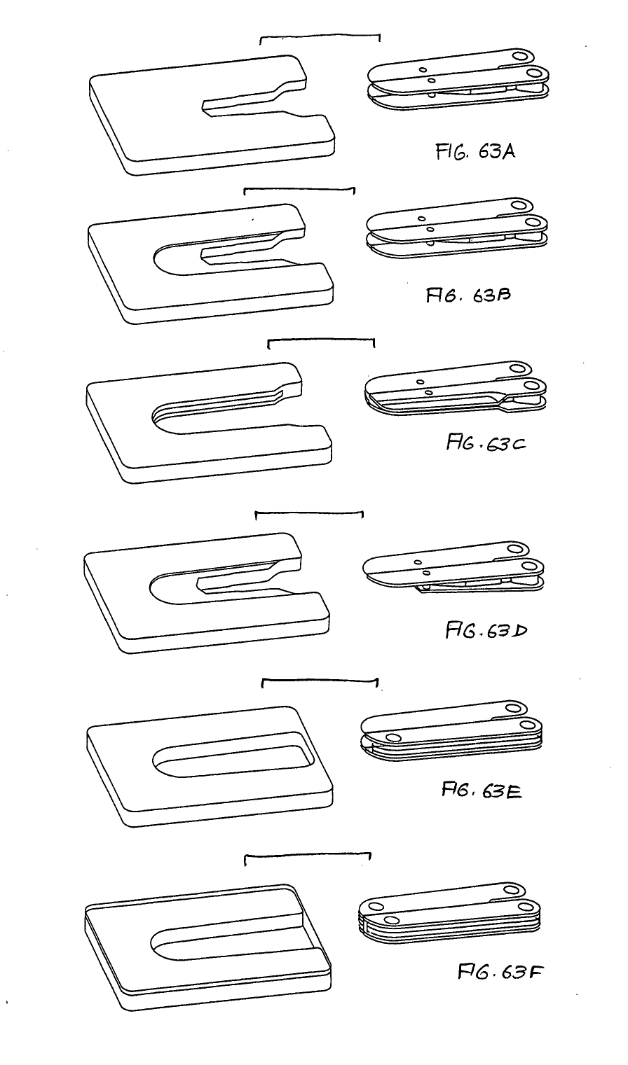

FIGS. 5 to 7 are views of a folding pruner and folding saw 22, FIG. 5 showing the saw 24 extended, while FIGS. 6 and 7 show the saw retracted and the plier 26 moved from the generally closed position in FIG. 6 to the open position in FIG. 7. FIGS. 8 to 10 show a plier with a hammer 30, FIG. 8 showing a side view indicating the plier 32 in the arm 34, while FIG. 9 shows the plier 32 in the closed position. The arm 36 is appropriately rotated so as to move the plier 32 into the extendable, usable position, as shown in FIG. 10.

In FIGS. 11 to 15, the plier is shown with a utility knife 40, FIG. 12 showing the extended knife 42 and the closed plier 44, and FIG. 12 showing the withdrawn knife 42 and the extended plier 44. FIGS. 13, 14 and 15 show different types of blades 46 which can be used.

In FIGS. 16 to 18, the folding plier is shown with a flashlight 50. FIG. 16 shows the flashlight 52 alone, when removed from the plier 54. FIG. 17 shows the folding plier 54 in the closed position with the flashlight 52 secured therein, and FIG. 18 shows the unfolded plier 54 in the open position. The flashlight 52 may be fixed within the plier arm 56, or it may be removable. An appropriate switch 58, as shown in the Figures, is illustrated to illuminate the flashlight 52.

FIGS. 19 to 21 show the folding plier and a ratchet wrench and screw driver accessories 60. FIG. 19 shows the ratchet and screw driver accessories 62 which may be separately packed, while FIG. 20 shows the folding plier 64 with an arm 66 to accommodate the ratchet and accessories 62, as shown in the top view of FIG. 21.

FIGS. 22 to 24 show a folding plier with a screw driver socket and accessories 70. FIG. 22 shows the folded plier 72 in the closed position and the socket arms 74 open to receive the screw driver 76. Various different shapes of screw driver 76 may be stored, as shown. FIGS. 23 and 24 show the folded plier 72 in the closed and open position respectively.

FIGS. 25 to 28 show the folding plier as part of a fisherman's accessory 80. FIG. 25 shows a tape measure 82 on one side, retractable into a container 84, and a fishing scale 86 for weighing fish on the other. FIG. 26 shows a front view, better illustrating these components. FIGS. 27 and 28 show the device with the folded plier 88 in the closed and open positions respectively.

FIGS. 29 to 37 show different views of a plier card 90, indicating the different tools. FIGS. 29 and 30 show the card 90, FIG. 29 with the screw driver bit holder 92 inserted, and FIG. 30 with the screw driver bit holder 92 removed. It will be seen that various different tools, such as a scissors 94 in FIG. 33, a knife 96 in FIG. 34, alternate nail file and screw drivers 98 in FIG. 35, different screw driver bits 100 in FIG. 36, are shown. FIGS. 31 and 32 show the screw driver bit holder 102, and FIG. 32 shows a ball point pen 104, also contained within the sleeve 106. FIG. 37 shows a screw driver bit 108. The darkened portion in these Figures refers to a magnet 110, which can be used to keep the components in position. The holder 102 in FIGS. 31 and 32 snaps into the side of the case 90, and the holder 102 can contain a large number of different devices, such as screw driver, pen, fire starter and the like.

FIGS. 38 to 41 show examples of a folding plier 120 from a plier card included in other tool bodies. FIG. 38 shows the foldable tool plier 120 standing alone, when in the closed position. FIGS. 39 and 40 show utility knives 122 and 124, FIG. 39 without the folding plier 120 inserted therein, and FIG. 40 with the folding plier 120. FIG. 41 shows a hammer 126 with a folding plier 128 inserted in the base or handle 130 thereof.

With reference to FIGS. 42 to 45, a folding plier 140 standing alone is illustrated, closed in FIG. 42 and pivoted open in FIG. 43 about pivot point 142.

Folding pliers that contain tools within their arms typically have arms of equal length. The current invention allows a pair of folding pliers to be incorporated into the handle or main body of a larger tool case. This is done by creating one arm of a folding plier by adding a narrow projection at the end of a larger tool body. The projection holds only a plier head via a pivot point at the end. A shorter, narrow arm anchors the opposite side of the plier head with a corresponding pivot point. This shorter articulated arm of the plier can contain additional tools since it can have a second pivot point at the end opposite the plier head. When this arm is closed it actually completes the overall handle/tool case shape, to provide a safe and comfortable grip for the entire tool assembly.

Unlike typical folding pliers, there is no second pivot point here to connect the two sides of the plier arm and allow for other tools. If the plier head is narrow and the arms are fairly short, only one or two tools may be incorporated in the articulated arm. If the plier head is wider and the arms are longer, three or more tools may be incorporated in the articulated plier arm.

FIGS. 46 to 51 are various illustrations indicating a folding plier tool and card combination. FIG. 46 shows the foldable plier tool 150 within the card 152, and FIG. 47 shows a schematic view of the card 152 with the folding plier 150 removed. FIGS. 48A, 48B, 48C and 48D show different side views, 48A being slightly narrower than 48B and the positioning in 48C being slightly off-set with respect to that shown in 48D. FIG. 49 shows the folding plier as it approaches insertion into the card 152. FIG. 51 shows the plier tool 150 when unfolded, the plier tool having a working or tool end 156, and arms 158 and 160 which pivot about points 162 and 164 so as to either encompass the working tool end 156 when folded or expose the working tool end 156 when unfolded for use.

Folding pliers are typically designed to hold a multitude of tools. The pliers in the plier card are unique in that they do not have pivot pins in the end of one or both of the arms opposite the plier head. This means that the arms will usually contain within them only a plier or shear or scissor or other articulated head or a combination.

This construction allows the sides of the plier arms to slide onto a card like substrate with the plier head resting in a cavity within the card, in the following illustrative manners:

(a) The sides of the plier arms lay on the surface of the card.

(b) The sides of the plier arms can be recessed into the surface of the card.

(c) The card cross section can be any shape.

(d) The plier can be located at any position or orientation in the card.

The sides of the card can be folded over to provide a more comfortable grip when the plier is used. Further, the sides of card may be connected by this member. It could be structured in various different ways and positions.

With respect to FIGS. 52 to 57, a different embodiment is shown for inserting a folding plier 170 within a card 172. FIGS. 52 and 53 show a magnet 174 at the inner end for securing the plier tool 170, while FIG. 54 indicates a mechanical locking mechanism 176 which can be provided to hold the plier tool 170 securely in place until needed. FIG. 55 indicates a view of the folded plier 170 outside of the card 172, while FIG. 56 show end views of the plier tool 170 as inserted in the card 172 indicated in FIG. 53. FIG. 57 shows three end views of the card with plier inserted therein as indicated in FIG. 54.

FIGS. 58 to 62 show a gardening tool card 180. FIG. 58 shows the folded gardening tool 182 within the card 184, while FIG. 59 shows the folded gardening tool 182 outside the card. In FIG. 60, the gardening tool 182 is in the open position. FIGS. 61 and 62 show alternatives, including a spring-loaded thorn stripper 186, a molded grip 188 for increased comfort, a spring 190 for keeping the plier 182 in place, a tape measure 192, a power lens 194 or magnifier, and a large tweezer 196 which can be removed as desired. Also, near the bottom right-hand corner there is shown a lanyard hole 198 for an attachment to the card 180.

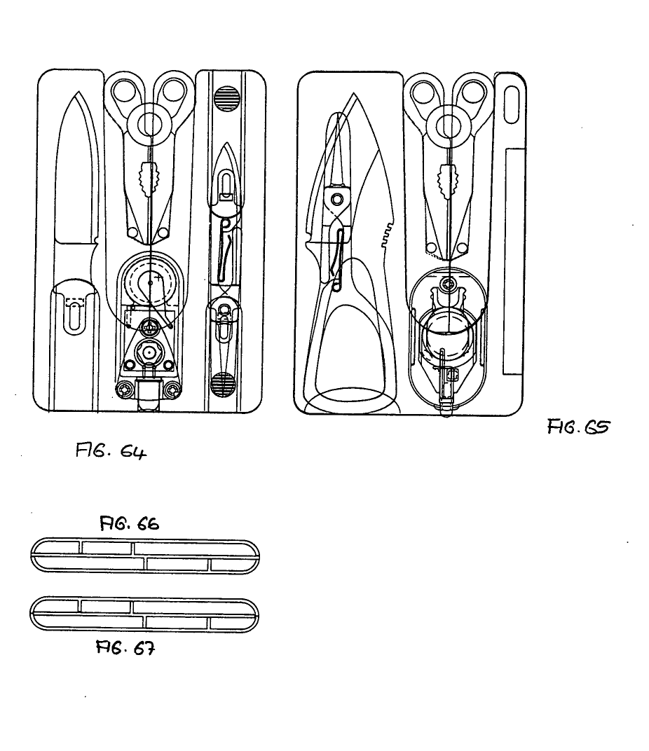

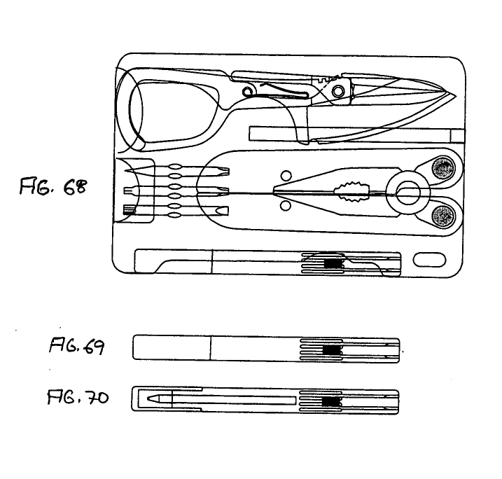

FIGS. 63A to 63F show the fit of the plier 200 into a main body of the card 202, with different embodiments of the configuration of the card and the folding plier respectively.

FIG. 63A: The plier arms are empty. They slide over the surface of the main body and the plier head rests in a cavity in the main body.

FIG. 63B: The plier arms are empty. They slide into a recessed area in the surface of the main body and the plier head rests in the main body.

FIG. 63C: The plier arms are empty. The outer edges of the folded plier are narrow. They slide into a recessed track within a cavity in the main body.

FIG. 63D: The plier arms are empty. One side of the plier has abbreviated arms. They slide into a recessed area in the surface of the main body and the plier head rests in a cavity in the main body.

FIG. 63E: The plier has tools in one or both of the arms. It drops into a cavity in the main body. This can be a completely open cavity or it can have a base and/or cover plate.

FIG. 63F: The plier has tools in one or both of the arms. It slides into a cavity on the front surface of the main body. This can be a completely open cavity or it can have a base and/or cover plate.

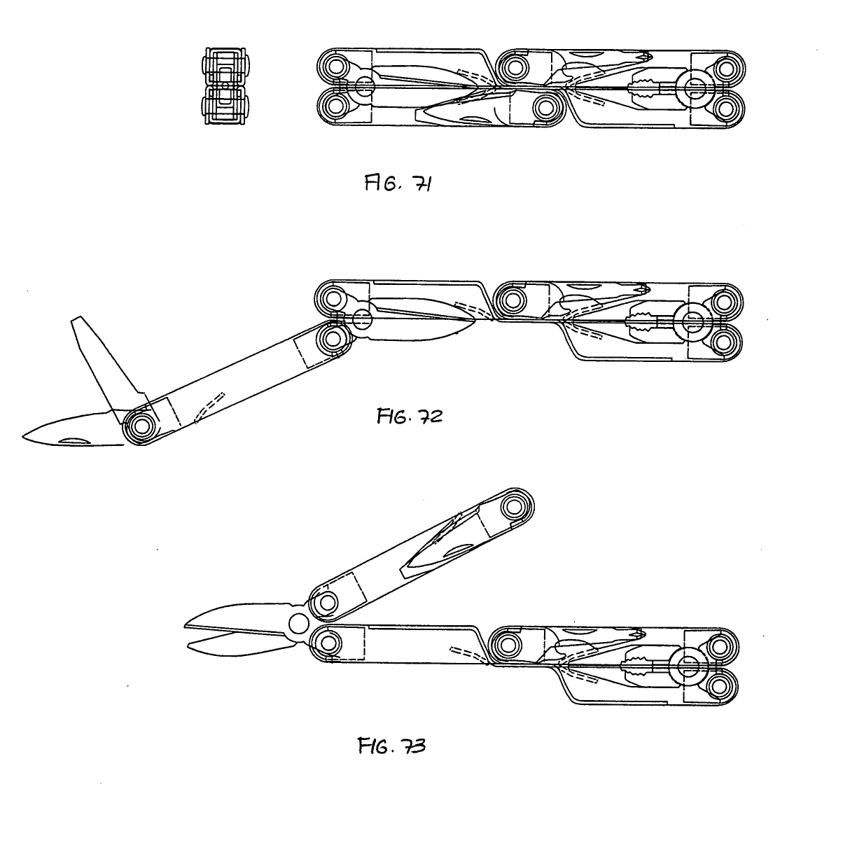

FIGS. 64 to 77 show the card substrate structure, FIGS. 66 and 67 indicating the cross-section with supports. The card substrate can include a lighting element including a battery, light source and switch mechanism. The card substrate can be any shape or cross-section. It can be made into two or more layers and will have a means of defining interior compartments to accommodate a wide variety of implements and other contents.

FIGS. 68 to 70 show a slot in the edge of a plier card similar to that shown above. Different tools may be placed within the card, as shown.

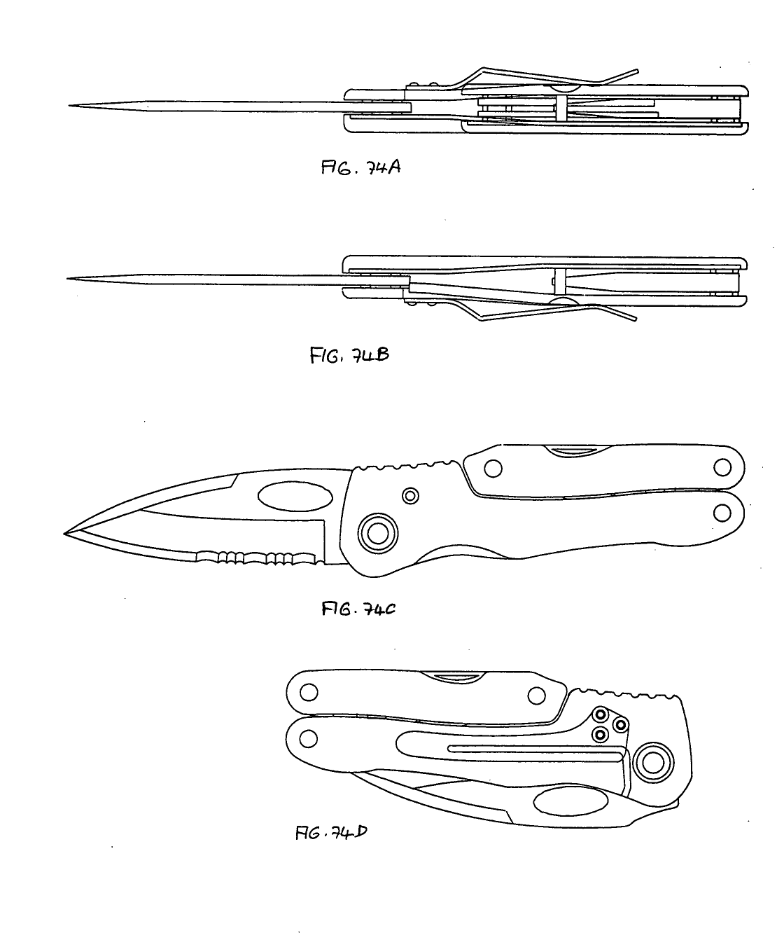

FIGS. 71 to 73 show different plier/shear heads in opposite ends of one folding tool. The same concept could, of course, be applied to large or small plier jaws, needle nose and other structures. FIG. 72 shows the unfolding of the knife and screw driver arrangement, while FIG. 73 shows the unfolding of the plier.

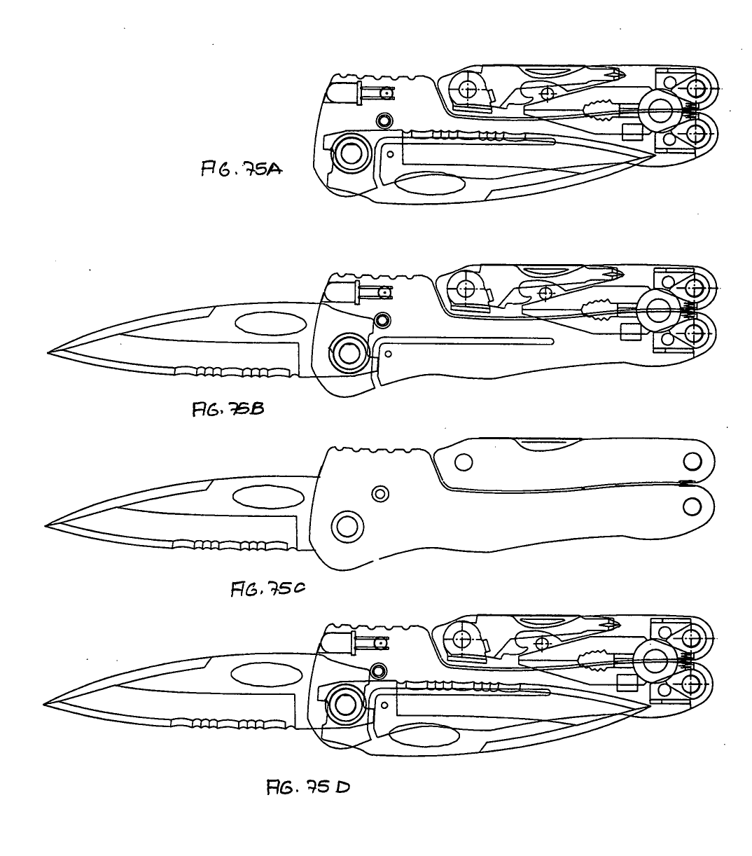

FIGS. 74A to 74D show four different views of the knife. FIG. 74A shows a top view of one embodiment, while FIG. 74B shows the bottom view of the same knife. FIG. 74C shows a plier with knife as illustrated in FIGS. 74A and 74B with the knife extended, and the plier retracted. FIG. 74D shows the knife retracted, as is the plier tool.

The invention is not limited to the precise details hereinbefore described or illustrated. Various modifications may be made within the scope of the invention.

1. A foldable plier combination tool comprising:
a foldable plier having a working head portion and a handle portion having a pair of arms which are operable to manipulate the working head portion to open and close, at least one of the arms being pivotably connected to the foldable plier so as to move between an extended position where the plier is unfolded and a retracted position where the plier is folded, the arm receiving at least a part of the working head portion when in the retracted position; and
an associated tool for connection to the foldable plier.

2. A foldable plier combination as claimed in claim 1 wherein the associated tool is a tool card.

3. A foldable plier combination as claimed in claim 1 wherein the associated tool is selected from one or more of the following: knife, shear, hammer, utility knife, flashlight, ratchet, screwdriver, tape measure, scale and gardening tool, or a combination thereof.

4. A foldable plier combination as claimed in claim 1 wherein both of the arms of the handle fold from the extended position to the retracted position.

5. A foldable plier combination as claimed in claim 1 wherein the arm has a recess therein for receiving at least a portion of the working head portion.

6. A foldable plier combination as claimed in claim 1 wherein the arm of the handle accommodates a tool foldable therein.

7. A foldable plier combination as claimed in claim 2 wherein the tool card has a recess therein configured to receive the plier when in the folded position.

8. A foldable plier combination as claimed in claim 1 wherein the plier is permanently connected to the associated tool.

9. A foldable plier combination as claimed in claim 1 wherein the plier is releasably connected to the associated tool.

10. A foldable plier combination as claimed in claim 7 wherein the tool card has a fastening member for engaging the plier to keep from falling out of the tool card when mounted therein.

11. A foldable plier combination as claimed in claim 1 wherein the working head portion of the plier may be configured to a wide variety of shapes and forms to comport with a selected task.

12. A foldable plier combination as claimed in claim 2 wherein the tool card is constructed of at least an upper layer and a lower layer, the upper and lower layers being spaced from each other by at least one inner wall.

13. A foldable plier combination as claimed in claim 12 wherein a plurality of inner walls are provided which define compartments for receiving the plier and other tools.

14. A foldable plier combination as claimed in claim 1 wherein two working head portions are provided in a single foldable plier combination.

15. A foldable plier combination as claimed in claim 14 wherein the two working head portions are formed at opposing ends of the foldable plier combination and each have separate handles.

16. A foldable plier combination tool comprising:
a foldable plier having a working head portion and a handle portion having a pair of arms which are operable to manipulate the working head portion to open and close, one arm being pivotably connected to the foldable plier so as to move between an extended position where the plier is unfolded and a retracted position where the plier is folded, the arm receiving at least a part of the working head portion when in the retracted position; and
an associated tool body that is longer than the plier arm, the tool body having a narrow extension at one end that forms a second arm of the foldable plier, the narrow extension being at least long enough to accommodate the length of the folded plier working head portion, the narrow extension containing only one pivot pin that is at an end thereof where it connects to the plier head.

17. A foldable plier tool comprising:
a foldable plier having a working head portion and a handle portion having a pair of arms which are operable to manipulate the working head portion to open and close, both arms being pivotably connected to the foldable plier head so as to move between an extended position where the plier is unfolded and a retracted position where the plier is folded, at least one arm receiving at least a part of the working head portion when in the retracted position, at least one of the arms of the plier having only one pivot pin within it, and the pivot pin is connected to the plier working head portion.

18. A foldable plier tool as claimed in claim 17 wherein both arms of the plier are of substantially similar length.

19. A foldable plier as claimed in claim 16 wherein the associated tool body is a card-like substrate which has a recess therein configured to receive the plier when in the folded position.

20. A foldable plier as claimed in claim 16 wherein the working head portion of the plier may be configured to a wide variety of shapes and forms to comport with a selected task.
